(19) United States
(12) Patent Application Publication
(10) Pub. No.: US 2026/0099597 A1
(43) Pub. Date: Apr. 9, 2026

(54) CREATING AND EXTRACTING TRAINING DATA FROM STORAGE SYSTEMS TO TRAIN MACHINE LEARNING MODELS FOR RANSOMWARE DETECTION

(71) Applicant: International Business Machines Corporation, Armonk, NY (US)

(72) Inventors: Dionysios Diamantopoulos, Zurich (CH); Roman Alexander Pletka, Uster (CH); Slavisa Sarafijanovic, Zurich (CH); Nicolás Hernán Reátegui Rodríguez, Kilchberg (CH); Charalampos Pozidis, Thalwil (CH); Yves Alexandre Beraldo dos Santos, Houston, TX (US); Andrew D. Walls, San Jose, CA (US)

(21) Appl. No.: 18/907,467

(22) Filed: Oct. 4, 2024

(51) Int. Cl. G06F 21/56; G06N 20/00

(52) U.S. Cl. CPC G06F 21/56; G06N 20/00; G06F 2221/034

(57) ABSTRACT

A first snapshot of a first volume is created and a hidden volume is instantiated using the first snapshot. Ransomware traces are generated using the hidden volume and benign traces using the first volume. An advanced features table is generated based on the ransomware traces and the benign traces, where the advanced features table provides a summary of features extracted from the ransomware traces and the benign traces. Training data is generated based on the advanced features table and a machine learning model is trained using the training data.

### BACKGROUND

The present invention relates generally to the electrical, electronic and computer arts and, more particularly, to machine learning (ML) and network security.

In conventional computer storage systems, virtual volumes are typically defined on top of the underlying storage devices. These volumes can be infected by ransomware that can be detected, for example, at the operating system level by generating a signature of the applications running on the system and trying to match the generated signature against the signatures of known ransomware. Other detection techniques, including behavior-based and ML-based approaches, are also utilized at different levels, such as the file or block level. While signature-based methods can detect known strains, they typically fail against new variants. Behavior-based detection offers adaptability, but can suffer from false positives and may not effectively counter advanced obfuscation. Consequently, ML models based on storage traces are being introduced. Analyzing disk input/output (I/O) traces offers several advantages, such as capturing highly indicative features correlated with ransomware activity while maintaining robustness against code obfuscation. For example, one conventional system computes, for a storage device such as hard disk drive (HDD) or solid-state drive (SDD), the entropy of each I/O operation to the device, and then averages the entropy values over a time interval of, for example, 1 or 10 seconds during which write operations are active. Other signals used for ransomware detection include write data rate, read data rate and logical block address (LBA) variance for read and write operations. These signals form a feature vector per time interval, and these feature vectors are used as the input to train a machine learning model (such as a Random Forest or other conventional machine learning model) which is then used for detecting ransomware. In general, however, ransomware can prove difficult to detect and mitigate.

### BRIEF SUMMARY

Principles of the invention provide systems and techniques for creation and extraction of training data and training of machine learning models using the created training data. In one aspect, an exemplary method includes the operations of creating of a first snapshot of a first volume; instantiating a hidden volume using the first snapshot; generating ransomware traces using the hidden volume; generating benign traces using the first volume; generating an advanced features table based on the ransomware traces and the benign traces, where the advanced features table provides a summary of features extracted from the ransomware traces and the benign traces; generating training data based on the advanced features table; and training a machine learning model using the training data.

In one aspect, a computer program product comprises one or more tangible computer-readable storage media and program instructions stored on at least one of the one or more tangible computer-readable storage media, the program instructions executable by a processor, the program instructions comprising creating of a first snapshot of a first volume; instantiating a hidden volume using the first snapshot; generating ransomware traces using the hidden volume; generating benign traces using the first volume; generating an advanced features table based on the ransomware traces and the benign traces, where the advanced features table provides a summary of features extracted from the ransomware traces and the benign traces; generating training data based on the advanced features table; and training a machine learning model using the training data.

In one aspect, a system for detecting ransomware programs comprises one or more volumes configured to store system data and perform input/output operations and trace collection; a hidden volume configured as a replica of one of the one or more volumes; a features aggregator configured to generate, using a mixed workload, feature vectors of advanced features tables based on benign traces derived using one of the one or more volumes and ransomware traces derived using the hidden volume; and a machine learning model trained using the advanced features tables and configured to detect ransomware on at least one of the volumes based on inference input/output traces.

In one aspect, a computer program product comprises one or more tangible computer-readable storage media and program instructions stored on at least one of the one or more tangible computer-readable storage media, the program instructions executable by a processor, the program instructions comprises creating of a first snapshot of a first volume; instantiating a hidden volume using the first snapshot; generating ransomware traces using the hidden volume; generating benign traces using the first volume; generating an advanced features table based on the ransomware traces and the benign traces, where the advanced features table provides a summary of features extracted from the ransomware traces and the benign traces; generating training data based on the advanced features table; and training a machine learning model using the training data.

In one aspect, a system comprises a memory and at least one processor, coupled to the memory, and operative to perform operations comprising creating of a first snapshot of a first volume; instantiating a hidden volume using the first snapshot; generating ransomware traces using the hidden volume; generating benign traces using the first volume; generating an advanced features table based on the ransomware traces and the benign traces, where the advanced features table provides a summary of features extracted from the ransomware traces and the benign traces; generating training data based on the advanced features table; and training a machine learning model using the training data.

As used herein, “facilitating” an action includes performing the action, making the action easier, helping to carry the action out, or causing the action to be performed. Thus, by way of example and not limitation, instructions executing on a processor might facilitate an action carried out by instructions executing on a remote processor, by sending appropriate data or commands to cause or aid the action to be performed. Where an actor facilitates an action by other than performing the action, the action is nevertheless performed by some entity or combination of entities.

Techniques as disclosed herein can provide substantial beneficial technical effects, as will be discussed further below. Features and advantages will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1 is an example architecture for a host system configured to detect ransomware, in accordance with example embodiments;

FIG. 2 is a high-level diagram of a first example machine learning system for training a machine learning (ML) model to detect ransomware based on feature information from the storage system, in accordance with example embodiments;

FIG. 3 is a high-level diagram of a second example machine learning system for training a ML model to detect ransomware based on feature information from a storage system, in accordance with example embodiments;

FIG. 4 illustrates examples of a host interacting with the volume and the hidden volume, in accordance with example embodiments;

FIG. 5A illustrates an example architecture for collecting traces and generating original feature tables (OFTs) and advanced feature tables (AFTs) using a mixed workload and a hidden volume, in accordance with example embodiments;

FIG. 5B illustrates example intermediate AFTs and final AFTs (such features based on synthetic mixed ransomware traces) generated using a mixed workload and a hidden volume, in accordance with example embodiments;

FIG. 6 illustrates an example architecture for generating training data using a hidden volume, in accordance with example embodiments;

FIG. 7 illustrates an example architecture for training a machine learning model using a hidden volume and detecting ransomware using the trained machine learning model, in accordance with example embodiments; and

FIG. 8 depicts a computing environment according to an embodiment of the present invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

Principles of inventions described herein will be in the context of illustrative embodiments. Moreover, it will become apparent to those skilled in the art given the teachings herein that numerous modifications can be made to the embodiments shown that are within the scope of the claims. That is, no limitations with respect to the embodiments shown and described herein are intended or should be inferred.

Given the discussion herein (reference characters refer to the drawings discussed below), it will be appreciated that in one aspect, an exemplary method, according to an aspect of the invention, includes the operations of creating of a first snapshot of a first volume 240-1, 240-2, . . . , 240-N (operation 550); instantiating a hidden volume 252 using the first snapshot; generating ransomware traces 616 using the hidden volume 252; generating benign traces 612 using the first volume 240-1, 240-2, . . . , 240-N; generating an advanced features table 540 based on the ransomware traces 616 and the benign traces 612, where the advanced features table 540 provides a summary of features extracted from the ransomware traces 616 and the benign traces 612 (operation 554); generating training data based on the advanced features table 540; and training a machine learning model 266 using the training data.

The technical benefits include:
systems and methods for detecting ransomware on storage volumes using machine learning models and hidden volumes;
techniques for generating training data for detecting ransomware without jeopardizing production computing environments;
utilization of ransomware workloads to generate training data for detecting ransomware without jeopardizing production computing environments;
collection of input/output (I/O) traces for storage system volumes for both benign and ransomware workloads;
collection of input/output (I/O) traces directly in the client system environments (including client test environments, pre-production environments and production environments);
summarization of the collected input/output (I/O) traces into original feature tables and advanced feature tables for both benign and ransomware workloads;
techniques for merging the original feature tables and advanced feature tables for both benign and ransomware workloads, including time-aware and logical block addressing (LBA)-aware modes;
machine learning models customized for ransomware detection using client (production environment) workloads (where access is provided to client workloads in order to fine-tune a machine learning model with more accuracy and lower false positives compared to a baseline model); and
generic ransomware workloads that can be ingested to obtain concrete representative benign and ransomware workloads, with minimal additional use of resources (e.g. 0.5% in average if the system has 200 volumes) and system operation disruption.

In example embodiments, the first volume 240-1, 240-2, . . . , 240-N is classified as benign or infected using the trained machine learning model 266. The technical benefits include a classification of a volume 240-1, 240-2, . . . , 240-N as being either benign or infected.

In example embodiments, the generating the ransomware traces 616 using the hidden volume 252 further comprises selecting parameters of a ransomware simulator 248 (also referred to as a ransomware emulator) to mimic one or more malicious ransomware strains and running the ransomware simulator 248. The technical benefits include developing training data for specific strains of a ransomware attack.

In example embodiments, the generating the ransomware traces 616 using the hidden volume 252 further comprises running real ransomware 278.

The technical benefits include developing training data for real ransomware.

In example embodiments, an original feature table 258-1 is generated based on the benign traces 612 and a ransomware feature table 258-2 is generated based on the ransomware traces 616; and wherein the generating the advanced features table 540 is based on the original feature table 258-1 and the ransomware feature table 258-2. The technical benefits include the generation of advanced features for training data for ransomware attack detection. In example embodiments, the generating of an advanced features table is based on the original features table, where the advanced features table is the result of collecting data from the original features table (where the collection can be done based on conditional selection and/or processing, such as summarization, filtering, aggregation, windowing and the like). The original features table may be generated or an existing original features table may be utilized.

In example embodiments, an effectiveness of the features aggregator 636 is determined and the features aggregator 636 is reconfigured based on the determined effectiveness. The technical benefits include refining the effectiveness for the generation of features and advanced features for training data for ransomware attack detection.

In example embodiments, the instantiating the hidden volume 252 using the first snapshot further comprises selecting one or more filesystems to format the hidden volume 252 and selecting one or more utilization percentages for loading the hidden volume 252. The technical benefits include understanding and replicating various aspects of the volume 240-1, 240-2, . . . , 240-N to ensure that the hidden volume 252 accurately mirrors the conditions of the original volume 240-1 which is particularly important for performance analysis, anomaly detection, and other storage-related assessments.

In example embodiments, the training is conducted periodically to improve an accuracy of the machine learning model 266; when new ransomware strains are available; and when new system configurations are instantiated. The technical benefits include keeping the training data for ransomware attack detection up-to-date to address new ransomware strains, new system configurations and the like.

In example embodiments, the generating the advanced features table 540 is based on one or more of merging the benign traces 612 and the ransomware traces 616 using concatenation, merging the benign traces 612 and the ransomware traces 616 using a time-aware mechanism and merging the benign traces 612 and the ransomware traces 616 using a space-aware mechanism. The technical benefits include the generation of a wide variety of training data for ransomware attack detection.

In example embodiments, the summary of features is generated by re-centering feature information on a mean of the benign traces 612 and a mean of the ransomware traces 616 and combining results into a single value. The technical benefits include the generation of more accurate training data for ransomware attack detection.

In example embodiments, a second snapshot of a second volume 240-1, 240-2, . . . , 240-N (operation 550) is created, wherein the instantiating the hidden volume 252 uses the first snapshot and the second snapshot and wherein the generating benign traces 612 uses the first volume 240-1, 240-2, . . . , 240-N and the second volume 240-1, 240-2, . . . , 240-N. The technical benefits include overcoming limitations on processing capabilities (such as a limit on the number of volumes 240-1, 240-2, . . . , 240-N that can be supported) as the scale of the system increases.

In example embodiments, a ransomware attack is detected using the machine learning model 266 and the detected ransomware attack is mitigated. The technical benefits include mitigating a detected ransomware attack.

In example embodiments, software running on the hidden volume 252 directly generates mixed ransomware traces 624 and a new machine learning model is trained using the mixed ransomware traces 624, wherein the software comprises benign applications and at least one of real ransomware and emulated ransomware. The technical benefits include an improved technique for generating mixed ransomware traces 624 and mixed ransomware training data.

In example embodiments, the first volume is a member of a specified volume group, wherein the specified volume group includes multiple volumes 240-1, 240-2, . . . , 240-N, wherein the hidden volume 252 refers to a hidden volume group and an additional snapshot of at least one other volume 240-1, 240-2, . . . , 240-N of the specified volume group is created, wherein the instantiating of the hidden volume 252 uses the first snapshot and the additional snapshot. The technical benefits include a mechanism for generating training data based on a plurality of volumes 240-1, 240-2, . . . , 240-N.

In one aspect, a system for detecting ransomware programs comprises one or more volumes 240-1, 240-2, . . . , 240-N configured to store system data and perform input/output operations and trace collection; a hidden volume 252 configured as a replica of one of the one or more volumes 240-1, 240-2, . . . , 240-N; a features aggregator 636 configured to generate, using a mixed workload, feature vectors 640 of advanced features tables 540 based on benign traces 612 derived using one of the one or more volumes 240-1, 240-2, . . . , 240-N and ransomware traces 616 derived using the hidden volume 252; and a machine learning model 266 trained using the advanced features tables 540 and configured to detect ransomware 224 on at least one of the volumes 240-1, 240-2, . . . , 240-N based on inference input/output traces 628.

The technical benefits include:
systems and methods for detecting ransomware on storage volumes using machine learning models and hidden volumes;
techniques for generating training data for detecting ransomware without jeopardizing production computing environments;
utilization of ransomware workloads to generate training data for detecting ransomware without jeopardizing production computing environments;
collection of input/output (I/O) traces for storage system volumes for both benign and ransomware workloads;
collection of input/output (I/O) traces directly in the client system environments (including client test environments, pre-production environments and production environments);
summarization of the collected input/output (I/O) traces into original feature tables and advanced feature tables for both benign and ransomware workloads;
techniques for merging the original feature tables and advanced feature tables for both benign and ransomware workloads, including time-aware and logical block addressing (LBA)-aware modes;
machine learning models customized for ransomware detection using client (production environment) workloads (where access is provided to client workloads in order to fine-tune a machine learning model with more accuracy and lower false positives compared to a baseline model); and
generic ransomware workloads that can be ingested to obtain concrete representative benign and ransomware workloads, with minimal additional use of resources (e.g. 0.5% in average if the system has 200 volumes) and system operation disruption.

In example embodiments, an evaluator 676 evaluates a performance of the machine learning model 266. The technical benefits include determining a performance of the machine learning model 266 to enable further refinement of the machine learning model 266.

In example embodiments, a feature importance analyzer 680 is configured to determine an effectiveness of the advanced features tables 540 provided by the features aggregator 636. The technical benefits include determining a performance of the effectiveness of the advanced features tables 540 to further refine of the features aggregator 636.

In example embodiments, the machine learning model 266 is trained to produce a classification 684 for each volume 240-1, 240-2, . . . , 240-N. The technical benefits include a classification of the volume 240-1, 240-2, . . . , 240-N as being either benign or infected by ransomware.

In example embodiments, the machine learning model 266 is further configured to generate a classification confidence 688. The technical benefits include providing a confidence of the classification of the volume 240-1, 240-2, . . . , 240-N as being either benign or infected by ransomware.

In one aspect, a computer program product comprises one or more tangible computer-readable storage media and program instructions stored on at least one of the one or more tangible computer-readable storage media, the program instructions executable by a processor, the program instructions comprising creating of a first snapshot of a first volume 240-1, 240-2, . . . , 240-N (operation 550); instantiating a hidden volume 252 using the first snapshot; generating ransomware traces 616 using the hidden volume 252; generating benign traces 612 using the first volume 240-1, 240-2, . . . , 240-N; generating an advanced features table 540 based on the ransomware traces 616 and the benign traces 612, where the advanced features table 540 provides a summary of features extracted from the ransomware traces 616 and the benign traces 612 (operation 554); generating training data based on the advanced features table 540; and training a machine learning model 266 using the training data.

The technical benefits include:
systems and methods for detecting ransomware on storage volumes using machine learning models and hidden volumes;
techniques for generating training data for detecting ransomware without jeopardizing production computing environments;
utilization of ransomware workloads to generate training data for detecting ransomware without jeopardizing production computing environments;
collection of input/output (I/O) traces for storage system volumes for both benign and ransomware workloads;
collection of input/output (I/O) traces directly in the client system environments (including client test environments, pre-production environments and production environments);
summarization of the collected input/output (I/O) traces into original feature tables and advanced feature tables for both benign and ransomware workloads;
techniques for merging the original feature tables and advanced feature tables for both benign and ransomware workloads, including time-aware and logical block addressing (LBA)-aware modes;
machine learning models customized for ransomware detection using client (production environment) workloads (where access is provided to client workloads in order to fine-tune a machine learning model with more accuracy and lower false positives compared to a baseline model); and
generic ransomware workloads that can be ingested to obtain concrete representative benign and ransomware workloads, with minimal additional use of resources (e.g. 0.5% in average if the system has 200 volumes) and system operation disruption.

In one aspect, a system comprises a memory and at least one processor, coupled to the memory, and operative to perform operations comprising creating of a first snapshot of a first volume 240-1, 240-2, . . . , 240-N (operation 550); instantiating a hidden volume 252 using the first snapshot; generating ransomware traces 616 using the hidden volume 252; generating benign traces 612 using the first volume 240-1, 240-2, . . . , 240-N; generating an advanced features table 540 based on the ransomware traces 616 and the benign traces 612, where the advanced features table 540 provides a summary of features extracted from the ransomware traces 616 and the benign traces 612 (operation 554); generating training data based on the advanced features table 540; and training a machine learning model 266 using the training data.

### Ransomware Detection In Storage Systems

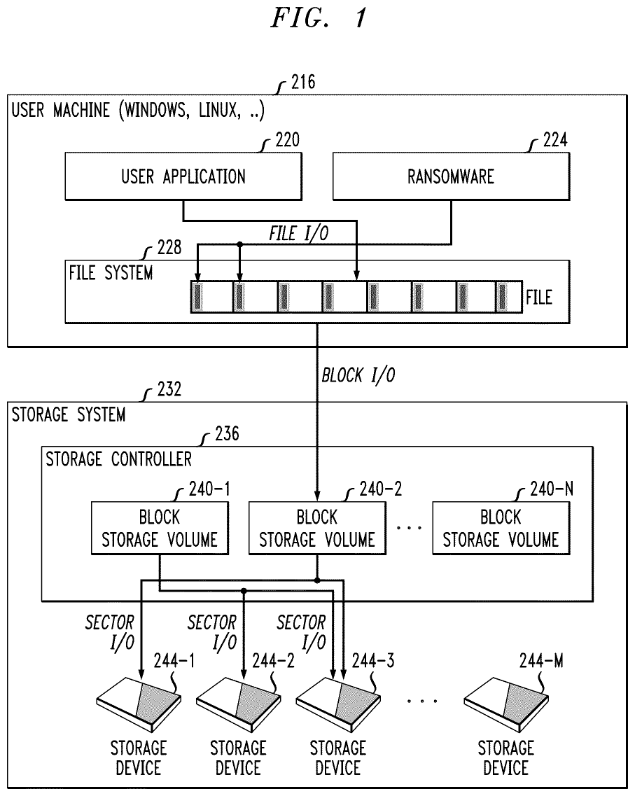

FIG. 1 is an example architecture for a host system configured to detect ransomware 224, in accordance with example embodiments. User applications 220 running on a user machine 216 access block storage volumes 240-1, 240-2, . . . , 240-N via a file system 228 and a storage controller 236. The block storage volumes 240-1, 240-2, . . . , 240-N organize data on the storage devices 244-1, 244-2, . . . , 244-M. A small computational unit in the storage device 244-1, 244-2, 244-3, . . . , 244-M (referred to as a computational storage device (CSD) herein) can be used to gather information on the input/output (I/O) operations on the volumes 240-1, 240-2, . . . , 240-N, such as counts of reads and writes. Such signals can be used to detect the ransomware 224.

The capability of a storage system 232 to detect the ransomware 224 and issue an alert is considered an important technical advantage. Conventional systems compute the observed sectors'entropies and use those as a signal (typically in combination with other signals) for detecting presence of the ransomware 224 at a volume or storage system level. Conventional systems also use such signals as features for machine learning to train a model to detect the ransomware 224. Specifically, the collected feature information is used to detect ransomware attacks within the storage system 232 using an inference engine. In storage systems where the computational storage devices (CSD) implement feature collection for ransomware detection, each CSD performs feature extraction of the corresponding input/output (I/O) operations. The CSD can further perform feature summarization (where each CSD summarizes its own features for a specified time interval (such as every 2 seconds)) based on the extracted features from the I/O operations during, for example, specified time intervals. In example embodiments, aggregation is performed, for example, by the storage controller 236 to aggregate features from a plurality of CSDs. In example embodiments, traces are captured by software or firmware running in the CSD.

### Use of Storage-Device Signals and Their Use in Machine Learning

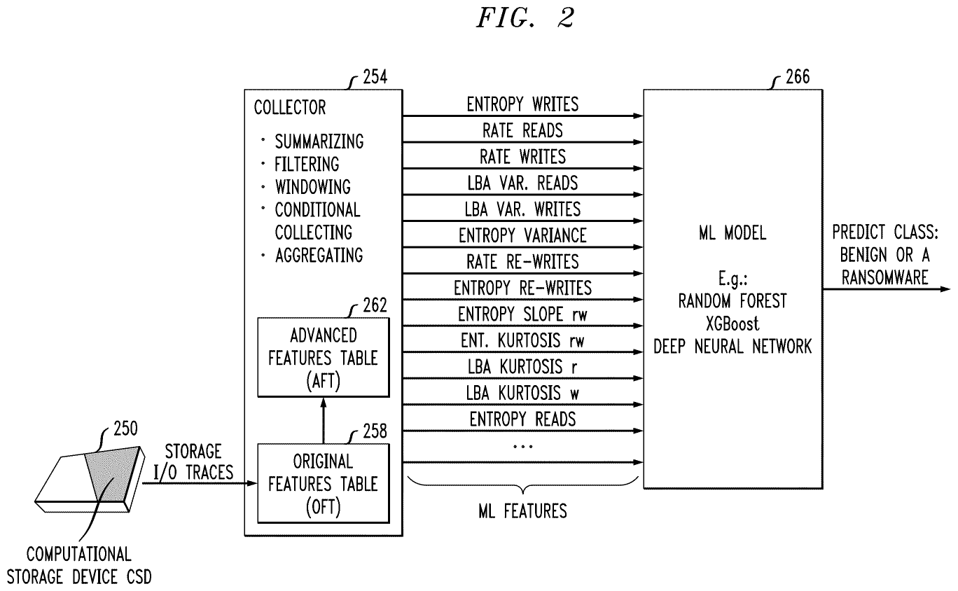

FIG. 2 is a high-level diagram of a first example machine learning system for training a ML model 266 to detect ransomware 224 based on feature information from the storage system 232, in accordance with example embodiments. As noted above, in storage systems 232 with computational storage devices (CSD) 250 that implement feature collection for ransomware detection, each CSD 250 performs feature extraction and summarization of input/output (I/O) operations. For example, entropy writes, read rates, write rates and the like can be collected by, for example, the CSD 250 and stored in an original features table (OFT) 258 for each volume or set of volumes 240-1, 240-2, . . . , 240-N. (It is noted that entropy writes are a measure of randomness, where entropy is high for encrypted data, such as data encrypted by ransomware.)

In example embodiments, features are collected for a specified period of time (over a time window), such as for one second, ten seconds, one minute and the like, to generate, for example, an average or mean of a given feature. An advanced features table (AFT) 262 is similarly generated based on the OFT 258 and/or the collected features. In example embodiments, there is an OFT 258 and an AFT 262 for each volume 240-1, 240-2, . . . , 240-N so that the ransomware 224 can be detected on, for example, a per-volume basis. (Generating an aggregate OFT 258 and an AFT 262 for a plurality of volumes 240-1, 240-2, . . . , 240-N is contemplated for instances where the data of the volumes 240-1, 240-2, . . . , 240-N is related. For example, a volume group can be defined, where each volume group includes several of the volumes 240-1, 240-2, . . . , 240-N. As the scale of the system increases, there may be limitations on processing capabilities (such as a limit on the number of volumes 240-1, 240-2, . . . , 240-N that can be supported). In example embodiments, volume grouping is done at the level of the controller 236 and the aggregation of the features is performed for the defined volume group using the techniques described herein.) The AFT 262 can be compiled using summarizing, filtering, windowing, conditional collecting, aggregating and the like, as described more fully below. For example, entropy variance, LBA variance reads, LBA variance writes and the like can be generated based on the features of the OFT 258. The advanced features of the AFT 262 can be generated using the same windows as the OFT 258, or using different windows (different periods of time).

In example embodiments, a machine learning model 266 is trained using the features of the OFT 258 and the AFT 262. The machine learning model 266 can be implemented using a random forest model, a conventional regularizing gradient boosting framework, a deep neural network, a time-series machine learning model and the like. Once trained, the machine learning model 266 generates a predicted class, such as an indication of whether a volume 240-1, 240-2, . . . , 240-N contains ransomware 224 or does not contain ransomware (benign software 220) (a benign volume 240-1, 240-2, . . . , 240-N). In example embodiments, the classification is multi-class where, for example, the suspected type of ransomware 224 or benign software 220 is also identified. Examples of multi-class labels include different ransomware threats (such as different conventional ransomware programs) and different benign software components (such as a conventional database, a conventional compression application, a conventional mail server, conventional video streaming software and the like).

To ensure high accuracy of the machine learning (ML) model 266, labeled traces that are representative of both benign workloads and ransomware workloads should be collected for the training of the ML model 266. Benign traces are generally readily available for collection using, for example, conventional production workloads. To obtain effective training data, however, ransomware traces also should be collected, typically from real ransomware attacks. These attacks, however, cannot be safely run on a production storage system (such as a client system) due to security and compliance aspects and concerns. Moreover, ransomware running on a volume 240-1, 240-2, . . . , 240-N where host applications are running may alter the application's behavior due to the effects of the ransomware 224 (known as, for example, traces illusion).

Note that collector 254 includes AFT 262 and OFT 258, and carries out activities such as summarizing, filtering, windowing, conditional collecting, and aggregating.

### Prerequisites and Issues for ML Training

### Problem 1: Imbalanced Traces

For training a ML model 266, it is beneficial to have a mixed workload (MW) of ransomware workload (RW; training data resulting from a ransomware attack) and realistic benign workload (BW; training data resulting from activities, such as running user applications 220, absent a ransomware attack) for a real volume 240-1, 240-2, . . . , 240-N in a real system deployment, where the RW training data is labelled as a ransomware attack (RA) and the BW training data is labelled as an absence of a ransomware attack (non-RA). It is desirable to obtain this for multiple volumes 240-1, 240-2, . . . , 240-N, and likely all various volumes 240-1, 240-2, . . . , 240-N present in the system, as well as labelled data for multiple samples for the BW and combinations of each with multiple RW, in order to use them as training data for the ML model. Moreover, in example embodiments, relatively equal amounts of RW and BW training data is preferred. A real production environment, however, may not be suitable for collecting traces using a ransomware workload as it is not desirable to subject the real production environment to ransomware 224. In a lab or other isolated environment, the data collection may not accurately replicate the real production environment, such as replicating the workloads of the client. On the other hand, as described in problem 2 below, if a database management system (DBMS) in a lab environment were intentionally infected with ransomware 224 to collect traces for a ransomware workload, the ransomware 224 may impair the performance of the DBMS to the point where only a ransomware workload is generated.

### Problem 2: Noisy Traces

Noisy traces may be affected by both noise for the system operation and for the training traces collection. Referring to quantum mechanics and analogizing to high-performance flash drives, simultaneous measurements cannot be taken for a particle's (FCM's) position (state) and its momentum (workload) without uncertainty (Heisenberg's uncertainty principle applied to FCM). (Note that IBM FLASHCORE® Modules (FCM) are a non-limiting example of high-performance flash drives, and IBM FLASHCORE® is a registered mark of International Business Machines Corporation, Armonk, NY, USA—references herein to FCM are to be understood as a non-limiting example of high-performance flash drives). Due to shared use of FCM across volumes, in one or more embodiments, a minimal disturbance to the overall system is desired, for both system operation and training workload collection. (Since one volume 240-1, 240-2, . . . , 240-N can span over multiple FCMs (e.g. in a RAID6 configuration, one volume 240-1, 240-2, . . . , 240-N spreads across 6 FCMs), there may be “noise” of one volume's I/O activity interfering with another volume's I/O activity. As such, when one volume 240-1, 240-2, . . . , 240-N has a user workload (e.g. database activity) and traces in another volume 240-1, 240-2, . . . , 240-N are collected (e.g. by running the ransomware emulator on the volume), the collected traces might be affected by the activity of the former volume 240-1, 240-2, . . . , 240-N.)

The capture of traces for a MW can be achieved by creating a replica of one of the original volumes 240-1, 240-2, . . . , 240-N at a time; that is, a replica of one of the original volumes 240-1, 240-2, . . . , 240-N is created in terms of both volume content and workload (the volume content snapshot is saved, and the original workload is recorded for a period of time). This can be repeated for workloads that include ransomware workloads and that exclude ransomware workloads, each time providing a realistic RA or non-RA workload. This can then be repeated for other volumes 240-1, 240-2, . . . , 240-N, i.e. repeated at different times for different volumes 240-1, 240-2, . . . , 240-N, or in parallel for a plurality of the volumes 240-1, 240-2, . . . , 240-N. After one repetition, the replica of the volume 240-1, 240-2, . . . , 240-N is removed and created again for another mixed workload combination at another time. As the system incorporates additional volumes 240-1, 240-2, . . . , 240-N (across the shared FCMs) or as new types of workloads are detected and added, the procedure can be repeated to address a new representation of the content and workloads. (In addition to problems 1 and 2 described above, a third problem (problem 3) is described below).

To address the problems described above, in an example storage system 232, computational storage devices 250 implement feature collection for ransomware detection, where each CSD 250 performs feature extraction of the storage system's I/O operations for a corresponding volume 240-1, 240-2, . . . , 240-N. The CSD 250 further performs feature summarization based on the features extracted from the I/O operations during given time intervals. The collected feature information is used by a trained inference engine to detect ransomware attacks within the storage system 232. Unfortunately, it is costly to train ML models 266 using labeled training data to create an inference engine for detecting ransomware 224. Although feature information for training can be collected periodically from storage systems 232 (e.g., using information sent to a conventional dashboard for monitoring the basic health, capacity, and performance of the storage system 232), those training sets only include the characteristics of the current workload which very likely does not include ransomware attacks.

### Feature Extraction With Hidden Volumes

In example embodiments, feature extraction is distributed over all CSDs 250 and performed on each volume 240-1, 240-2, . . . , 240-N individually. A hidden snapshot of a given volume 240-1, 240-2, . . . , 240-N is created and ransomware (emulated, simulated or both) is run on top of the hidden snapshot. The CSDs 250 automatically collect the feature information using the new hidden volume snapshot, which will be labeled as malicious training data since it is generated using ransomware (such as generated using known educational ransomware running inside the storage system 232 on the snapshot of the hidden volume 252). In example embodiments, both the original feature and aggregated feature extraction is performed in each CSD 250. It is noted that the CSDs 250 need not to know that they are extracting features on a hidden volume snapshot running a simulated or emulated ransomware attack. (In example embodiments, the original feature extraction, the aggregated feature extraction or both is performed external to the CSD 250.)

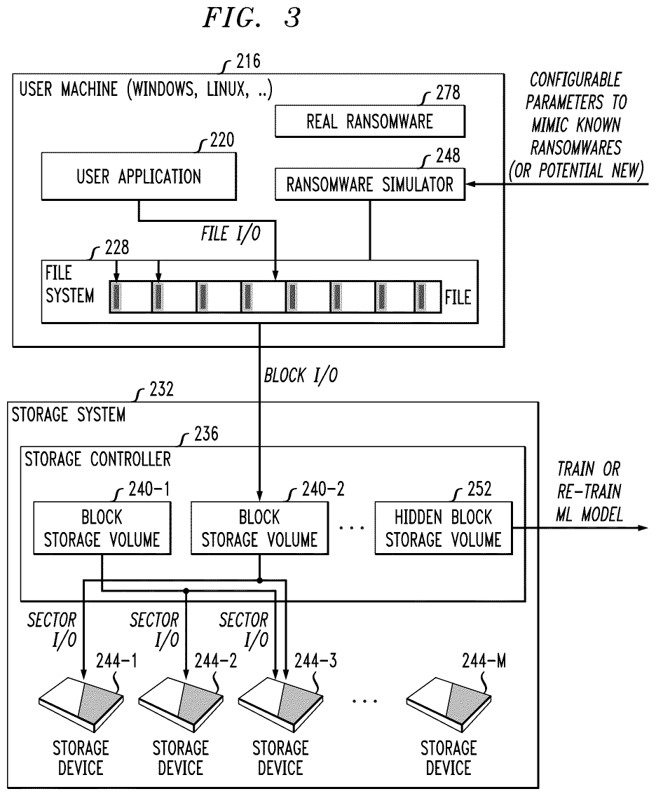

In a preferred embodiment, the CSD 250 distinguishes the original volumes 240-1, 240-2, . . . , 240-N and the hidden volumes 252 as seen in FIG. 3. The original volume information is aggregated as described above. For the hidden volume 252, the I/Os are merged with the I/Os for an existing original volume 240-1, 240-2, . . . , 240-N, thus merging features of benign and ransomware workloads. In example embodiments, the features extracted using the original volumes 240-1, 240-2, . . . , 240-N and the hidden volume(s) 252 are periodically sent to a conventional dashboard (IBM Storage Insights available from International Business Machines Corporation, Armonk, NY, USA is a non-limiting example) for monitoring the basic health, capacity, and performance of storage systems for re-training the ML models 266.

### Safely Training ML Models for Ransomware Detection

FIG. 3 is a high-level diagram of a second example machine learning system for training a ML model 266 to detect ransomware 224 based on feature information from a storage system 232, in accordance with example embodiments. A ransomware workload is generated using real ransomware 278 or using a ransomware simulator 248 that periodically replicates a ransomware workload to generate ransomware traces (a known ransomware emulator can be adapted by the skilled artisan, given the teachings herein)). A hidden block storage volume 252 (also referred to as a replica volume herein) is incorporated into the system where the replica volume 252 is loaded with data of an original volume 240-1, 240-2, . . . , 240-N. The data can include, for example, honey pot files, files with special attributes, such as many small files having a size of 4,096 kilobytes (KB), and the like. The ransomware simulator is then used to encrypt the hidden volume 252 using the techniques of the simulated ransomware. In example embodiments, the replica volume 252 can be generated via, for example, a snapshot of the original volume 240-1, 240-2, . . . , 240-N. (In addition, one or more of the user applications 220 that use the original volume 240-1, 240-2, . . . , 240-N can be copied for use with the hidden volume 252. The copied applications can be stored within the same replica volume 252 or a new hidden volume 252. For example, a database file and a Structured Query Language (SQL) application can be either on the same volume 240-1, 240-2, . . . , 240-N or separate volumes 240-1, 240-2, . . . , 240-N. The replica volume 252 needs to mirror this behavior. In the case of separate volumes 240-1, 240-2, . . . , 240-N, this can be done by either creating a replica with both of the volumes 240-1, 240-2, . . . , 240-N or two replica volumes 252, respectively.) In one or more embodiments, only the replica volume 252 is subjected to the ransomware software to protect the contents of the original volumes 240-1, 240-2, . . . , 240-N from the effects of a ransomware attack.

In example embodiments, I/O traces are collected by, for example, the CSD 250 of the corresponding storage device 244-1, 244-2, . . . , 244-M and are used to train the ML model 266. The training can be conducted: periodically to improve the accuracy of the ML model 266; when new ransomware strains are available; when new system configurations are instantiated and the like.

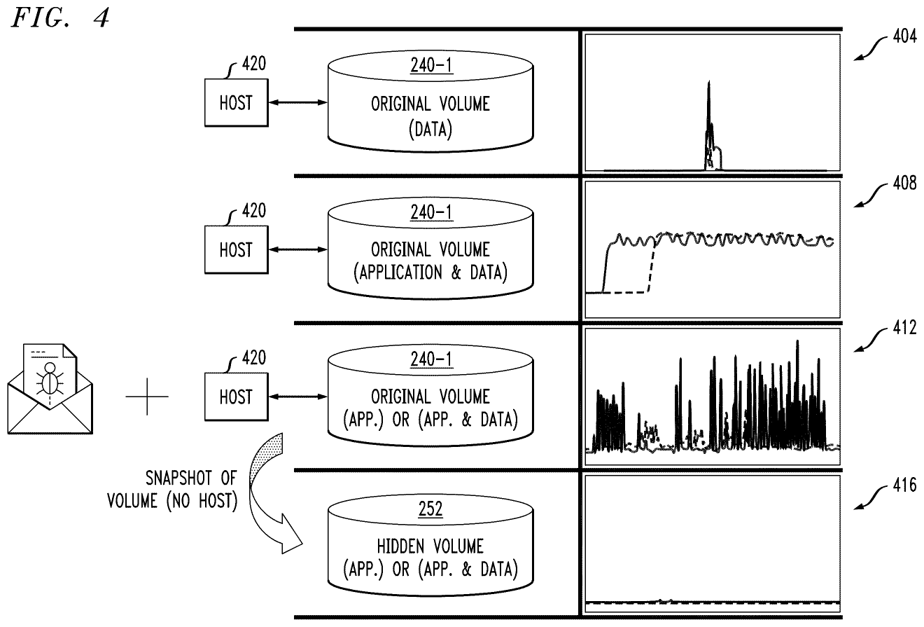

FIG. 4 illustrates examples of a host 420 interacting with the volume 240-1 and the hidden volume 252, in accordance with example embodiments. Graph 404 illustrates traces of a typical workload of a volume 240-1 of a client that stores data (such as a database). Graph 408 illustrates traces of a typical workload of a volume 240-1 of a client that stores both data (such as a database) and applications (such as applications 220, which can include basic functionality (“bare metal”) or the entire operating system (OS), a virtual machine (VM), a container and the like). Graph 412 illustrates traces from previous setups, when the host 420 that is attached to the volume 240-1 is also infected by ransomware 224. Graph 416 illustrates traces generated by the hidden volume 252 alone (an inactive volume); that is, when a snapshot of the volume 240-1 is created (without mounting the hidden volume 252 to a host), there is no I/O activity. In this regard, the third problem alluded to above is where to mount a hidden volume 252 in order to create RW traces (since a client's host 420 cannot be intentionally infected with the ransomware 224).

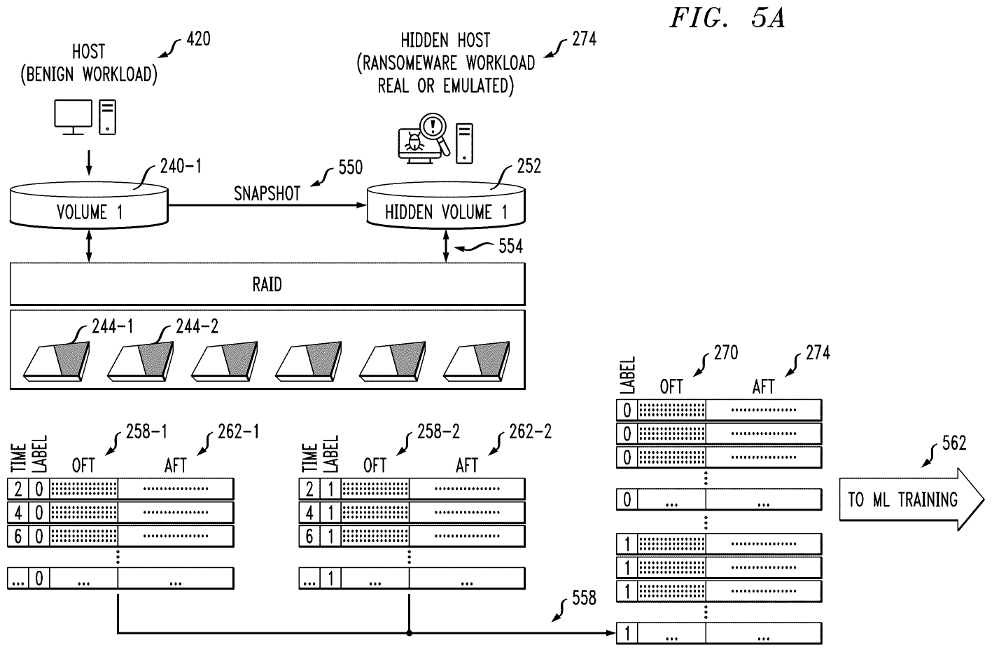

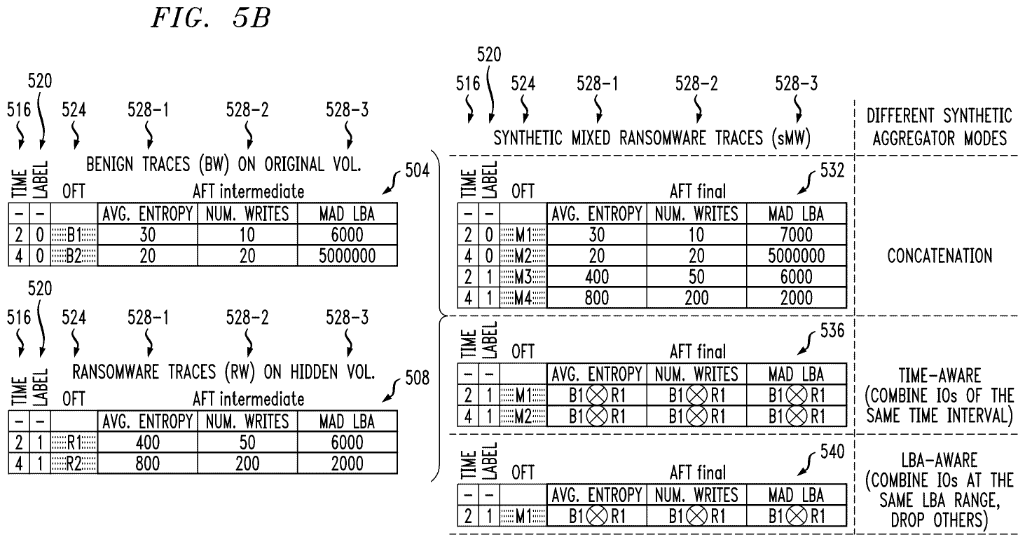

FIG. 5A illustrates an example architecture for collecting traces and generating OFTs 258-1, 258-2 and AFTs 262-1, 262-2 using a mixed workload and the hidden volume 252, in accordance with example embodiments. In example embodiments, a snapshot of the volume 240-1 of a user/client is created to generate the hidden volume 252 (operation 550). A hidden host 274 that can be isolated from communication networks is provided to generate real or emulated ransomware traces. Summaries of the OFTs 258-1 and AFTs 262-1 are generated for the original volume 240-1 using a benign production workload and summaries of OFTs 258-2 and AFTs 262-2 are generated for the hidden volume 252 using a ransomware workload (using either real ransomware 278 or ransomware simulator 248) run by the hidden host 274 (operation 554). In example embodiments, the hidden host 274 uses both a benign workload, such as a workload similar to that of the BW of the production environment, and the ransomware workload (either real or simulated). Thus, traces can be collected on the hidden volume 252 for the ransomware 224 alone, as well for a mixed workload (benign workload and ransomware workload integrated together). The OFTs 258-1, 258-2 can be collected, for example, every two seconds (as illustrated). In each OFT 258-1, 258-2, the label is the classification of the workload corresponding to the trace. The AFTs 262-1, 262-2 summarize features for one epoch and can be generated on the same timeframe as the OFTs 258-1, 258-2, such as every two seconds, or on a different timeframe, such as every ten seconds. An aggregator merges the benign and ransomware traces to generate merged OFT 270 and merged AFT 274 (operation 558). The merged tables (merged OFT 270 and merged AFT 274) are then utilized to train the ML model 266 (operation 562).

FIG. 5B illustrates example intermediate AFTs 504, 508 and final AFTs 532, 536, 540 (such features based on synthetic mixed ransomware traces) generated using a mixed workload and a hidden volume 252, in accordance with example embodiments. A features aggregator processes original traces and ransomware traces to generate, for example, the final AFTs 532, 536, 540. The processing of the features aggregator includes, for example, summarizing, filtering, windowing, conditional collecting, aggregating and the like. Conditional collecting refers to collecting features based on a conditional criterion, such as collecting features having a write-throughput of at least 1 kilobyte per second and entropy higher than 20/255 (a dimensionless parameter representing, in this case, 20 values out of a total of 255 values, and indicative of a ransomware activity). (In example embodiments, the Shannon entropy is a value between zero and eight and is computed by taking into account the probability of each byte in a sector. A value of zero represents a series of the same bytes and, hence, denotes low randomness and a value of eight represents a perfectly even distribution of byte values and, hence, high randomness. In another embodiment the entropy can be normalized from [0,8] to another data range, e.g. [0,256], [0, 1000] etc.) This conditional collection can result in the collection of more focused features for ransomware detection. It also helps in other aspects of the machine learning (ML) flow, such as reducing the space required to store training data, reducing training time, and the like. Intermediate AFT 504 summarizes benign traces on the original volume 240-1. As illustrated in FIG. 5B, traces are summarized every two minutes, as indicated by time column 516. A label column 520 indicates the classification result, where a 0 indicates a benign volume and a 1 indicates a volume infected with ransomware. A column 524 summarizes an original feature “B” for each time period. Columns 528-1, 528-2, 528-3 summarize intermediate advanced features, including average entropy (column 528-1), number of writes (column 528-2) and mean of absolute differences (MAD) LBA (column 528-3). Similarly, intermediate AFT 508 summarizes the same types of traces for ransomware workloads generated using the hidden volume 252. (Note, for example, the low entropy values (20-30) for the benign traces and the high entropy values (400-800) for the ransomware traces.)

In example embodiments, different synthetic aggregator modes are used to generate the final AFTs 532, 536, 540. For example, concatenation, time-aware and LBA-aware modes can be utilized. Moreover, two different extraction methods are also disclosed for aggregated features:

1) statistics, such as the average of the features, sum of the features and the like;

2) re-centering of feature information on the mean of original I/Os and the mean of the hidden I/Os before combining them into a single value.

In the latter extraction method, re-centered normalization is used to align features onto a similar scale, particularly addressing discrepancies, such as different feature ranges. This approach mitigates the risk of misleading results by ensuring balanced contributions from both sets of I/O traces. For example, features from the normal volume 240-1 might cluster around lower LBA values, while those from the hidden volume 252 might be concentrated around higher LBA values. Simply averaging these without normalization could yield misleading results. To address this, the feature information is re-centered. In example embodiments, normalization is utilized where the features from both volumes 240-1, 252 are adjusted relative to their respective means before combining them. This ensures that each feature contributes equally to the aggregated value, preventing any single feature from dominating due to scale differences. Various normalization techniques can be applied; for example, recalibrating the features around the mean of the original I/Os and the mean of the hidden IOs. This brings all features to a comparable scale. Other techniques include min-max normalization, Z-score normalization, log transformation, quantile transformation, a known software tool that scales features by maximal absolute value, unit vector normalization, and the like.

Final AFT 532 merges the traces of intermediate AFTs 504, 508 using concatenation where the features of the benign traces and the ransomware traces are concatenated together. Final AFT 536 merges the traces of intermediate AFTs 504, 508 using a time-aware mechanism where I/Os of the same time interval are combined. The time-aware combination can be the mean of the combined features, the average of the combined features, and the like. Final AFT 540 merges the traces of intermediate AFTs 504, 508 using an LBA-aware mechanism where I/Os features are combined at the LBA range, drop others and the features are aggregated for each LBA. In the LBA-aware method, “drop others” means that the features where the LBA is not within the same range between the original volume 240-1 and the hidden volume 252 need to be dropped and not used since, in this method, features that are generated from I/O activity in the same address space are to be merged. The above modes can be also utilized together in any combination.

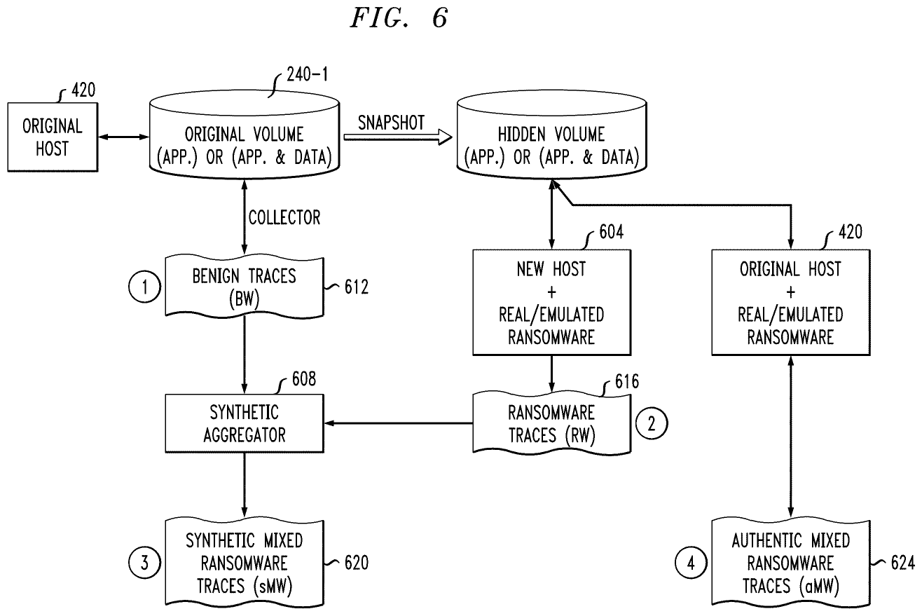

FIG. 6 illustrates an example architecture for generating training data using the hidden volume 252, in accordance with example embodiments. An original host 420 generates benign traces 612 by running applications, such as applications 220, using the original volume 240-1. A snapshot of the original volume 240-1 is taken to generate the hidden volume 252. Once the hidden volume 252 is established, two scenarios are defined for generating mixed ransomware data for training the ML model 266.

In example embodiments, a new host 604 hosts real ransomware 278 and/or ransomware simulator 248 and generates ransomware traces 616 using the hidden volume 252. A synthetic aggregator 608 then merges the ransomware traces 616 with the benign traces 612 to create synthetic mixed ransomware traces 620. The synthetic aggregator 608 can be implemented in software or firmware and can be run on the CSD 250 or another processor.

In example embodiments, the original host 420 also hosts real ransomware 278 and/or ransomware simulator 248 in addition to applications 220. The host 420 directly generates mixed ransomware traces 624 using the hidden volume 252 by running software on the hidden volume 252, wherein the software includes benign applications and at least one of real ransomware and emulated ransomware. A new machine learning model is trained using the mixed ransomware traces 624.

(In a real production environment, whenever a volume 240-1 is infected with real ransomware and a hidden volume 252 is not available, the traces can be utilized directly (assuming the feature collection is enabled on the given CSDs 250), as those traces are very valuable since they stem from a real-world ransomware attack.)

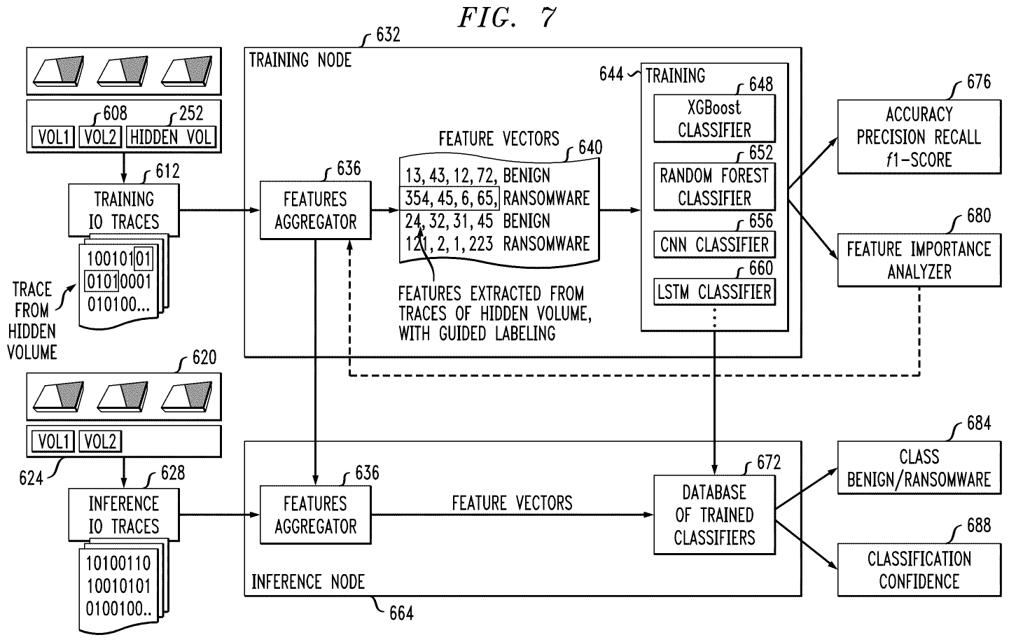

FIG. 7 illustrates an example architecture for training a machine learning model 266 using a hidden volume 252 and for detecting ransomware 224 using the trained machine learning model 266, in accordance with example embodiments. Production volumes 608 and a hidden volume 252 are used to generate training I/O traces 612. A features aggregator 636 generates feature vectors 640 of final AFTs 540 that represent a mixed workload (a benign workload and a ransomware workload). Training 644 is performed on a variety of machine learning models 266, such as a conventional regularizing gradient boosting framework 648 (e.g., a gradient boosting algorithm for supervised learning), random forest classifier 652, convolutional neural network (CNN) classifier 656, long short-term memory (LSTM) classifier 660 (or, more generally, time-series classification models), large language models and the like, on a training node 632. The results generated by the ML models 266 are evaluated by an evaluator 676 to generate evaluation parameters, such as accuracy, precision, recall, f1 analysis and the like. In example embodiments, the evaluator 676 is implemented using conventional evaluation techniques.

In example embodiments, a feature importance analyzer 680 determines the effectiveness of the features and the final AFTs 540 provided by the features aggregator 636. The results are utilized to improve the feature vectors 640 and the features aggregator 636. In example embodiments, an expert analyzes the results to improve the features aggregator 636.

Once the machine learning model 266 is trained, it can be used for classifying the volumes 240-1, 240-2, . . . , 240-N as being benign (not infected with ransomware 224) or infected (infected with ransomware 224). The trained model 266 can be incorporated into a database of trained classifiers 672 that can be used to perform the classification operation. In example embodiments, the volumes 240-1, 240-2, . . . , 240-N of a production environment 620 are monitored to collect inference I/O traces 628. The features aggregator 636 (incorporated into an inference node 664) processes the inference I/O traces 628 to generate feature vectors 640. One or more of the machine learning models 266 of the database of trained classifiers 672 are selected to process the feature vectors 640 and to produce a classification 684 of each volume 240-1, 240-2, . . . , 240-N (or set of volumes 240-1, 240-2, . . . , 240-N) as benign or infected (ransomware). The selected machine learning models 644 can also generate a classification confidence 688.

### Alternative Embodiments

The state of a volume 240-1, 240-2, . . . , 240-N (including its filesystem, workload, utilization, and other characteristics) plays a crucial role in determining the behavior of I/O operations. Understanding and replicating these aspects are essential to ensure that the hidden volume 252 accurately mirrors the conditions of the original volume 240-1. This is particularly important for performance analysis, anomaly detection, and other storage-related assessments. In example embodiments, existing models 266 are first evaluated and retrained with the new training data only if they underperform. This can be further improved by using a technology that guides the characteristics of the new hidden volume 252 (such as filesystem, workload, utilization and the like).

### Replicating Volume Characteristics

To create an effective hidden volume 252, the filesystem of the original volume 240-1, its utilization (such as 27% of the total area of the original volume 240-1) and other relevant aspects are replicated. By doing so, it is ensured that the hidden volume 252 exhibits similar I/O behavior under specific workloads. In example configurations, the technology of snapshotting is provided, in a non-limiting example, by IBM FLASHSYSTEM® and is used to replicate the original volume 240-1 and maintain those characteristics. (Note that IBM FLASHSYSTEM® products are a non-limiting example, and IBM FLASHSYSTEM® is a registered mark of International Business Machines Corporation, Armonk, NY, USA —references herein to IBM FLASHSYSTEM® products are to be understood as a non-limiting example).

When accumulations of the features are performed in the summarizer using original volumes 240-1, 240-2, . . . , 240-N and a hidden volume 252, the LBA accesses are likely not in the same range. As the MAD and histogram are centered around the mean, separate means can be calculated for the original volumes 240-1, 240-2, . . . , 240-N and the hidden volume 252, and then these means can be used to merge into a single metric for each LBA histogram bin and MAD.

It is noted that additional workload (WL) on the snapshot volume changes the overall workload. This should not necessarily be considered negative because the system workload can and will change, and the resulting WL noise due to use of the method is acceptable, at least from the ransomware detection point of view, even if more than one snapshot for RW simulation would be used at a time.

In addition, it is noted that the overhead needs to be distinguished from the obtaining of such workloads. From the user-perspective, i.e. the actor that uses the volumes 240-1, 240-2, . . . , 240-N, the goal is zero-overhead since a computational storage architecture is employed where the functionality for ransomware detection is on par with normal I/O operation and is not involved in the data-path. From the storage appliance perspective, i.e. the actor that provides the volumes 240-1, 240-2, . . . , 240-N to the users via, in a non-limiting example, a IBM FLASHSYSTEM® storage area network (SAN) volume controller (SVC) stack, overhead is incurred in central processing unit (CPU) and memory resources in order to aggregate the features from every summarizer within each non-volatile memory express (NVMe) drive (in a non-limiting example, implemented with an FLASHCORE® module). Thus, generic ransomware workloads that can be ingested to obtain concrete IBM FLASHSYSTEM®-specific representative benign and ransomware workloads are generated, derived from recent (where being on the order of months is more representative) system operation with minimal additional use of resources (such as 0.5% on average if the system has 200 volumes 240-1, 240-2, . . . , 240-N) and system operation disruption.

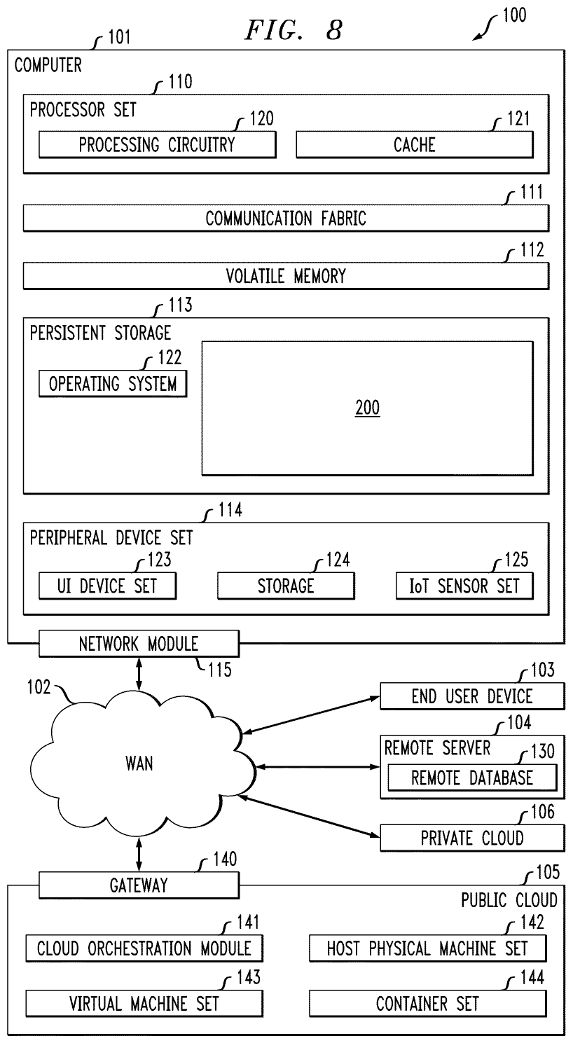

Refer now to FIG. 8.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as ransomware detection system 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images. ” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
creating of a first snapshot of a first volume;
instantiating a hidden volume using the first snapshot;
generating ransomware traces using the hidden volume;
generating benign traces using the first volume;
generating an advanced features table based on the ransomware traces and the benign traces, where the advanced features table provides a summary of features extracted from the ransomware traces and the benign traces;
generating training data based on the advanced features table; and
training a machine learning model using the training data.

2. The method of claim 1, further comprising classifying the first volume as benign or infected using the trained machine learning model.

3. The method of claim 1, wherein the generating the ransomware traces using the hidden volume further comprises:
selecting parameters of a ransomware simulator to mimic one or more malicious ransomware strains; and
running the ransomware simulator.

4. The method of claim 1, wherein the generating the ransomware traces using the hidden volume further comprises running real ransomware.

5. The method of claim 1, further comprising generating an original feature table based on the benign traces and generating a ransomware feature table based on the ransomware traces; and
wherein the generating the advanced features table is based on the original feature table and the ransomware feature table.

6. The method of claim 1, further comprising determining an effectiveness of the features aggregator and reconfiguring the features aggregator based on the determined effectiveness.

7. The method of claim 1, wherein the instantiating the hidden volume using the first snapshot further comprises:
selecting one or more filesystems to format the hidden volume; and
selecting one or more utilization percentages for loading the hidden volume.

8. The method of claim 1, wherein the training is conducted:
periodically to improve an accuracy of the machine learning model;
when new ransomware strains are available; and
when new system configurations are instantiated.

9. The method of claim 1, wherein the generating the advanced features table is based on one or more of merging the benign traces and the ransomware traces using concatenation, merging the benign traces and the ransomware traces using a time-aware mechanism and merging the benign traces and the ransomware traces using a space-aware mechanism.

10. The method of claim 1, further comprising generating the summary of features by re-centering feature information on a mean of the benign traces and a mean of the ransomware traces and combining results into a single value.

11. The method of claim 1, further comprising creating a second snapshot of a second volume;
and wherein the instantiating the hidden volume uses the first snapshot and the second snapshot and wherein the generating benign traces uses the first volume and the second volume.

12. The method of claim 1, further comprising detecting a ransomware attack using the machine learning model and mitigating the detected ransomware attack.

13. The method of claim 1, further comprising running software on the hidden volume 252 to directly generate mixed ransomware traces and training a new machine learning model using the mixed ransomware traces, wherein the software comprises benign applications and at least one of real ransomware and emulated ransomware.

14. The method of claim 1, wherein the first volume is a member of a specified volume group, wherein the specified volume group includes multiple volumes, wherein the hidden volume refers to a hidden volume group and further comprising creating an additional snapshot of at least one other volume of the specified volume group, wherein the instantiating of the hidden volume uses the first snapshot and the additional snapshot.

15. A system for detecting ransomware programs, the system comprising:
one or more volumes configured to store system data and perform input/output operations and trace collection;
a hidden volume configured as a replica of one of the one or more volumes;
a features aggregator configured to generate, using a mixed workload, feature vectors of advanced features tables based on benign traces derived using one of the one or more volumes and ransomware traces derived using the hidden volume; and
a machine learning model trained using the advanced features tables and configured to detect ransomware on at least one of the volumes based on inference input/output traces.

16. The system of claim 15, further comprising an evaluator for evaluating a performance and an accuracy of the machine learning model.

17. The system of claim 16, further comprising a feature importance analyzer configured to determine an effectiveness of the advanced features tables provided by the features aggregator.

18. The system of claim 16, wherein the machine learning model is trained to produce a classification for each volume.

19. The system of claim 16, wherein the machine learning model is further configured to generate a classification confidence.

20. A computer program product, comprising:
one or more tangible computer-readable storage media and program instructions stored on at least one of the one or more tangible computer-readable storage media, the program instructions executable by a processor, the program instructions comprising:
creating of a first snapshot of a first volume;
instantiating a hidden volume using the first snapshot;
generating ransomware traces using the hidden volume;
generating benign traces using the first volume;
generating an advanced features table based on the ransomware traces and the benign traces, where the advanced features table provides a summary of features extracted from the ransomware traces and the benign traces;
generating training data based on the advanced features table; and
training a machine learning model using the training data.

21. The computer program product of claim 20, the program instructions further comprising classifying the first volume as benign or infected using the trained machine learning model.

22. The computer program product of claim 20, the program instructions further comprising generating an original feature table based on the benign traces and generating a ransomware feature table based on the ransomware traces; and wherein the generating the advanced features table is based on the original feature table and the ransomware feature table.

23. A system comprising:
a memory; and
at least one processor, coupled to said memory, and operative to perform operations comprising:
creating of a first snapshot of a first volume;
instantiating a hidden volume using the first snapshot;
generating ransomware traces using the hidden volume;
generating benign traces using the first volume;
generating an advanced features table based on the ransomware traces and the benign traces, where the advanced features table provides a summary of features extracted from the ransomware traces and the benign traces;
generating training data based on the advanced features table; and
training a machine learning model using the training data.

24. The system of claim 23, the operations further comprising classifying the first volume as benign or infected using the trained machine learning model.

25. The system of claim 23, the operations further comprising generating an original feature table based on the benign traces and generating a ransomware feature table based on the ransomware traces; and wherein the generating the advanced features table is based on the original feature table and the ransomware feature table.
